(19) United States
(12) Patent Application Publication
(10) Pub. No.: US 2003/0202787 A1
(43) Pub. Date: Oct. 30, 2003

(54) Electronic coffee maker with scale removal alerting capability

(76) Inventor: Tsan-Kuen Wu, Tainan Hsien (TW)

Correspondence Address: TROP PRUNER & HU, PC, 8554 KATY FREEWAY, SUITE 100, HOUSTON, TX, 77024, US

(21) Appl. No.: 10/128,779

(22) Filed: Apr. 24, 2002

(51) Int. Cl. F24C 13/00; H05B 1/02

(52) U.S. Cl. 392/467; 219/494

(57) ABSTRACT

A control circuit of an electronic coffee maker includes a sensor unit for sensing temperature of a supply pipe and for generating a temperature signal corresponding to the temperature of the supply pipe, a processor for determining an average brewing temperature value of the supply pipe from the temperature signal, and for generating an alerting signal when the average brewing temperature value determined thereby reaches a preset scale removal temperature value, and an alert unit connected to the processor and operable for scale removal indication upon receipt of the alerting signal from the processor.

### BACKGROUND OF THE INVENTION

1. Field of the Invention

The invention relates to a coffee maker, more particularly to an electronic coffee maker with a scale removal alerting capability.

2. Description of the Related Art

In a conventional coffee maker, an electric heating device mounted in a base is controlled by a control circuit to heat a metal supply pipe. Water in a water reservoir is heated as it passes through the supply pipe, and drips into a filter basket that contains ground coffee. Brewed coffee from the filter basket is collected in a flask on the base.

During heating of the supply pipe by the electric heating device, calcium carbonate in the water will deposit and accumulate on the inner wall surface of the supply pipe, forming the so-called scale. When the deposit of scale has accumulated to a certain extent, the heating efficiency will be affected adversely. Therefore, removal of the scale on the supply pipe is necessary after a period of use of the coffee maker in order to ensure a desirable heating efficiency.

There are available coffee makers provided with a light indicator for alerting users to remove scale deposit on the supply pipe after a predetermined count of use. A common method of removing scale from the supply pipe is to add a cleaning agent containing citric acid to the reservoir, followed by activation of the coffee maker so that the scale is dissolved in the cleaning agent. The scale is subsequently removed by rinsing the supply pipe with water.

However, the determination as to when scale removal should be conducted based upon the count of use of the coffee maker is not reliable. This is because scale accumulation is closely associated with the quality of water in the place of use and the kind of water used to brew coffee. It is known that different kinds of water, such as tap water, mineral water and filtered water, can result in scale deposition to significantly differing extent. To illustrate, scale will soon form on the supply pipe if tap water is used to brew coffee. On the other hand, filtered water does not readily form scale within the supply pipe. In other words, a coffee maker using tap water may need scale removal while a coffee maker using filtered water may not. Improvement in this respect is thus desirable.

### SUMMARY OF THE INVENTION

Therefore, the object of the present invention is to provide an electronic coffee maker that is capable of accurately determining the time when scale removal is necessary for timely alerting the user.

According to this invention, an electronic coffee maker comprises a water reservoir for receiving water therein, a base disposed at a lower end of said water reservoir, a filter basket, and a control circuit mounted on the base. The base includes a housing, an electric heating device mounted in the housing, and a supply pipe in fluid communication with the water reservoir and heated by the electric heating device when electric power is supplied to the electric heating device. The filter basket is disposed above the base and is disposed to receive heated water from the supply pipe. The control circuit includes a sensor unit for sensing temperature of the supply pipe and for generating a temperature signal corresponding to the temperature of the supply pipe, a processor connected to the sensor unit, the processor determining an average brewing temperature value of the supply pipe from the temperature signal, and generating an alerting signal when the average brewing temperature value determined thereby reaches a preset scale removal temperature value, and an alert unit connected to the processor and operable for scale removal indication upon receipt of the alerting signal from the processor.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of the preferred embodiment of an electronic coffee maker according to the invention;

FIG. 2 is a fragmentary partly sectional view of the preferred embodiment;

FIG. 3 is a schematic block diagram of the preferred embodiment;

FIG. 4 is a schematic electric circuit diagram of the preferred embodiment; and

FIG. 5 is a temperature vs. time plot to illustrate brewing operations of the preferred embodiment with and without scales on a supply pipe.

### DETAILED DESCRIPTION OF THE PREFERRED EMBODIMENT

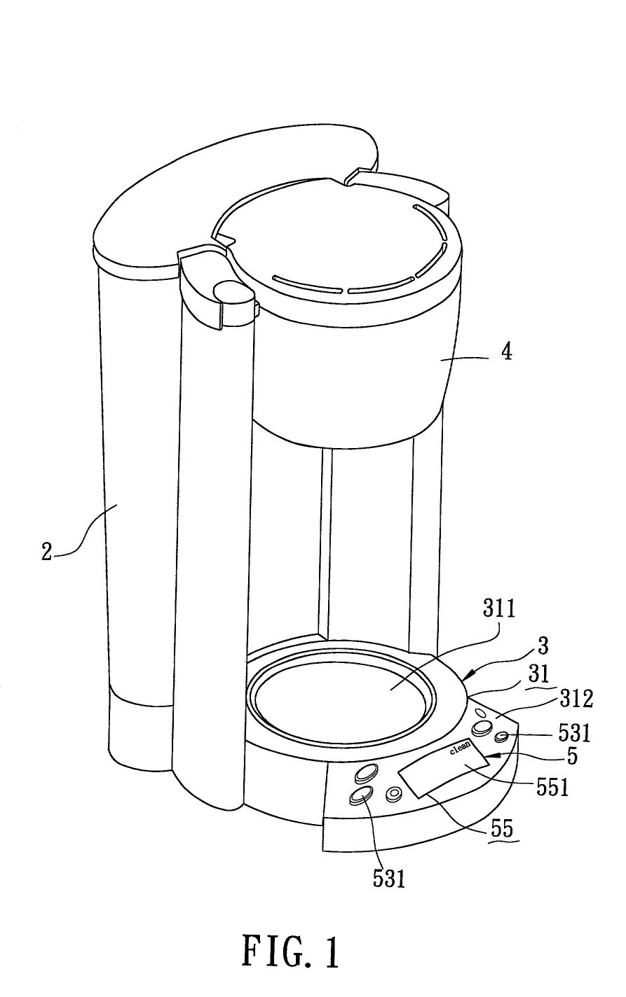

Referring to FIG. 1, the preferred embodiment of an electronic coffee maker according to the present invention is shown to include a water reservoir 2 for receiving water therein, a base 3 disposed at a lower end of the water reservoir 2, a filter basket 4 disposed above the base 3 and to be supplied with water from the water reservoir 2, and a control circuit 5 mounted on the base 3.

Since the constructions of the water reservoir 2 and the filter basket 4 are known to those skilled in the art, a detailed description of the same will be dispensed with herein for the sake of brevity.

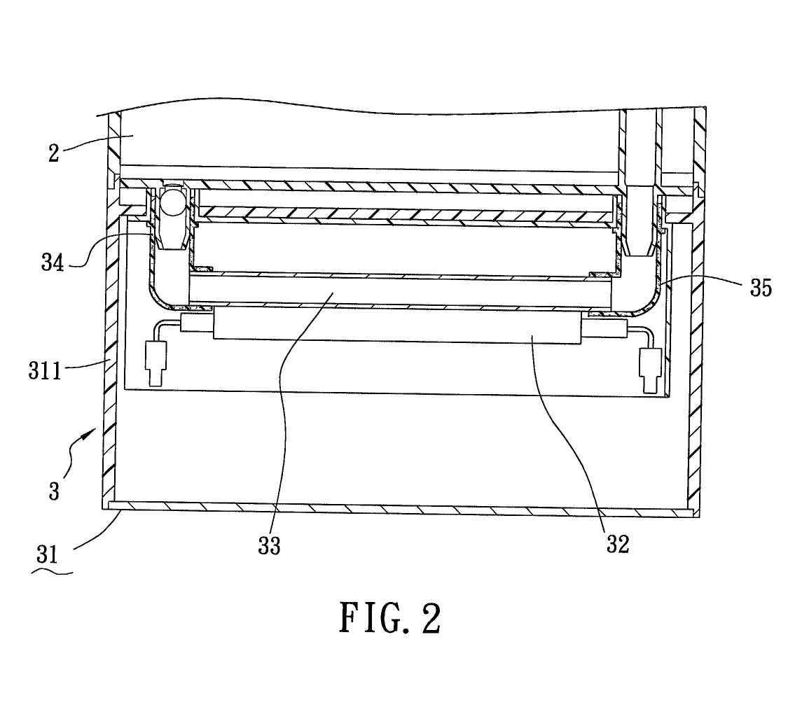

With further reference to FIG. 2, the base 3 includes a housing 31, an electric heating device 32 mounted in a rear portion 311 of the housing 31, and a supply pipe 33 in fluid communication with the water reservoir 2 and heated by the electric heating device 32. The supply pipe 33 is disposed horizontally in the rear portion 311 of the housing 31, and has an inlet tube 34 and an outlet tube 35 coupled to two ends thereof. The inlet tube 34 is used to draw water in the water reservoir 2 into the supply pipe 33. The electric heating device 32 is in contact with the supply pipe 33 such that, when electric power is supplied to the electric heating device 32, the electric heating device 32 radiates heat for rapidly heating the water flowing through the supply pipe 33. The outlet tube 35 is used to supply the heated water in the supply pipe 33 to the filter basket 4 in a conventional manner. Under normal conditions, water in the water reservoir 2 is continuously supplied to the filter basket 4 via the supply pipe 33 in the aforesaid manner until the water reservoir 2 has been emptied.

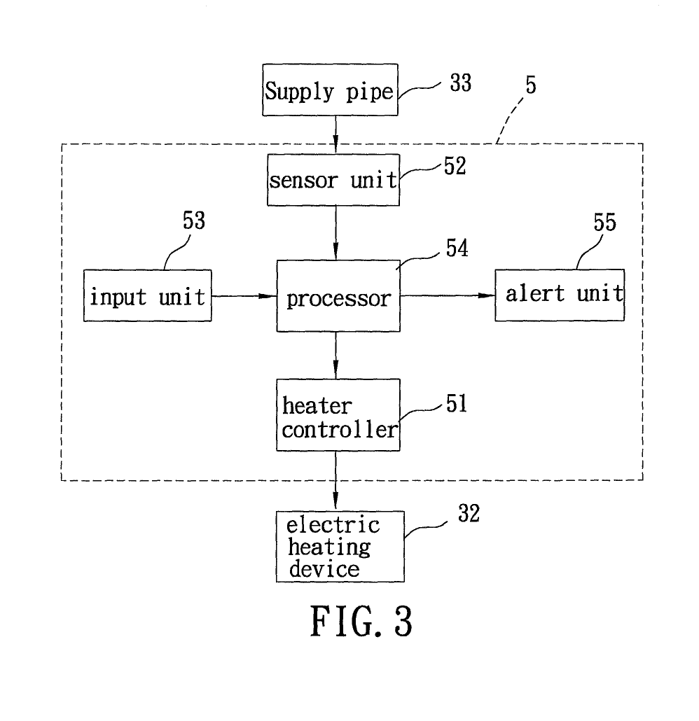

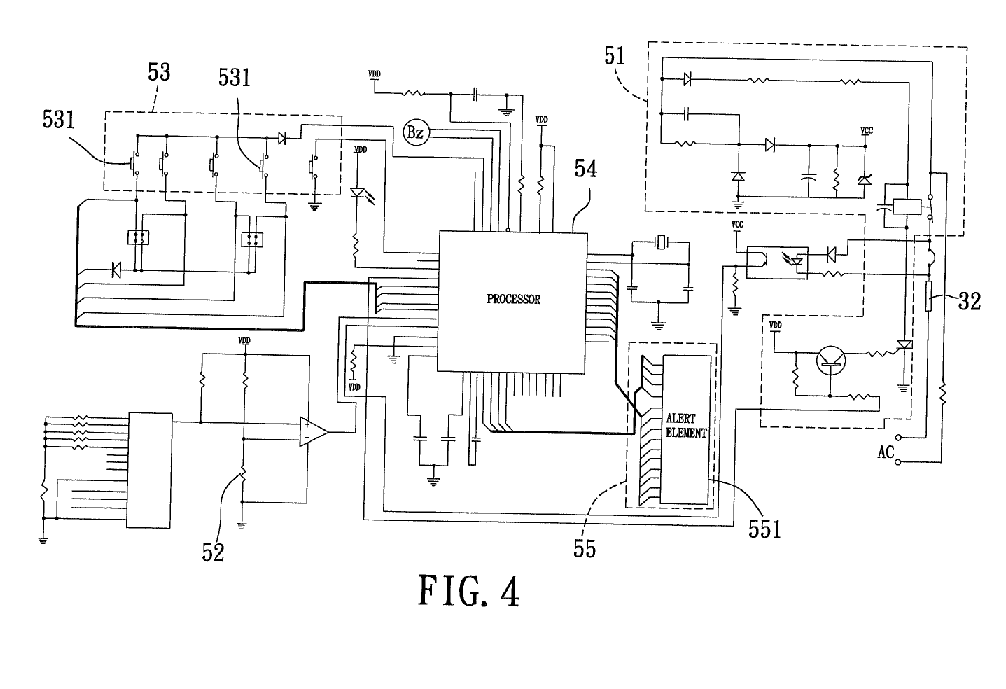

Referring further to FIGS. 3 and 4, the control circuit 5 is mounted on the housing 31 of the base 3, and includes an input unit 53, a heater controller 51 connected to the electric heating device 32 and operable so as to control electrical connection between the electric heating device 32 and an AC power supply, a sensor unit 52 for sensing the temperature of the supply pipe 33 and for generating a temperature signal corresponding to the temperature of the supply pipe 33, a processor 54 connected to the sensor unit 52, the input unit 53 and the heater controller 51, and an alert unit 55 connected to the processor 54.

The input unit 53 includes a plurality of push-button switches 531 mounted on a front portion 312 of the housing 31 of the base 3, as best shown in FIG. 1. The input unit 53 is operable so as to input brewing control settings, such as power activation, brewing time setting, brewing mode selection, and temperature and clock adjustment, for reception by the processor 54. Since the feature of the present invention does not reside in how the input unit 53 is operated for brewing control, a detailed description thereof will be dispensed with herein for the sake of brevity.

The sensor unit 52 is disposed to contact an outer wall of the supply pipe 33 such that it can sense the temperature of the supply pipe 33. The sensor unit 52 provides a temperature signal corresponding to the temperature sensed thereby to the processor 54.

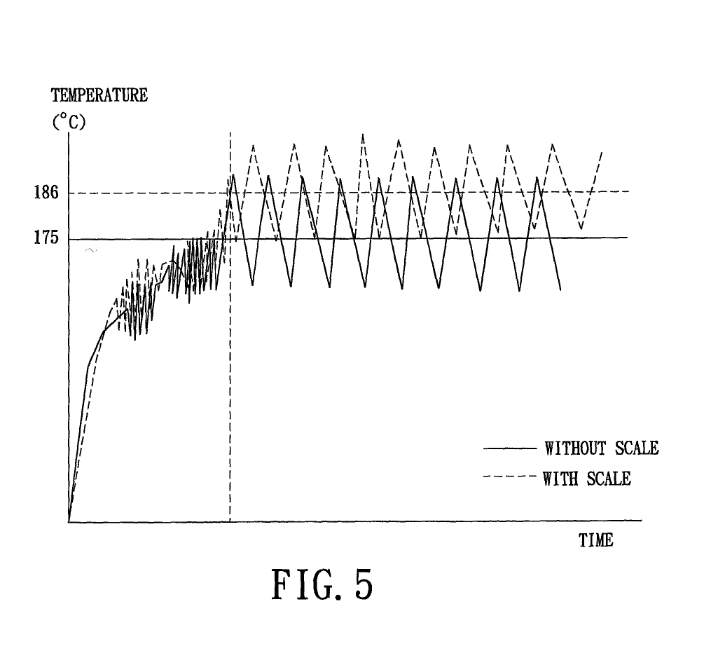

The processor 54 is configured by programming to control brewing operation of the coffee maker according to the brewing control settings inputted via the input unit 53. The processor 54 is connected to the sensor unit 52 for receiving the temperature signal, and controls the electric heating device 32 via the heater controller 52 based on the temperature signal provided by the sensor unit 52. In the present invention, the processor 54 is programmable to determine an average brewing temperature value of the supply pipe 33 by sampling the temperature signal from the sensor unit 52, which can be done in various ways. When the water in the supply pipe 33 is heated to about 100° C., i.e., the boiling point of water, for output to the filter basket 4 via the outlet tube 34, water in the water reservoir 2 will continue to flow into the supply pipe 33 until the water reservoir 2 is empty, thereby resulting in fluctuation of the temperature at the supply pipe 33, as best shown in FIG. 5. The average brewing temperature value is determined by the processor 54 by obtaining a mean temperature value of highest and lowest temperature samples at each fluctuation of the temperature signal within a predetermined period of brewing time (e.g., 3 seconds). For instance, a mean temperature value of twenty highest temperature samples and twenty lowest temperature samples may be obtained within the predetermined period of time. The average temperature of the water in the supply pipe 33 is approximately 100° C. prior to any deposit of scale on the inner wall surface of the supply pipe 33. However, since the sensor unit 52 is disposed externally of the supply pipe 33, taking into account the efficiency of heat conductivity of the supply pipe 33, the average brewing temperature value actually obtained by the processor 54 will be higher than 100° C., e.g., 175° C. Certainly, the determination of the average brewing temperature value can be obtained using a predetermined number of temperature values T1, T2˜Tn sampled during a predetermined period of time.

It is known that the scale accumulated on the inner wall surface of the supply pipe 33 has a direct adverse effect on the efficiency of heat conductivity. In other words, the temperature required to heat the water in the supply pipe 33 to the boiling point will increase with an increment in the thickness of the scale. Thus, the average brewing temperature value calculated by the processor 54 will gradually increase, e.g., from 175° C., 176° C., 177° C. to 186° C., or even higher, as best shown in FIG. 5. In this embodiment, a scale removal temperature value, e.g., 186° C., is preset in the processor 54 based on the aforesaid phenomenon. When the average brewing temperature value determined by the processor 54 reaches the preset scale removal temperature, the processor 54 will generate an alerting signal to indicate that the scale within the supply pipe 33 has accumulated to an extent that requires removal.

Lest that the processor 54 should untimely transmit an alerting signal due to a sudden rise of the sampled temperatures that results in an average brewing temperature value higher than the preset scale removal temperature, the processor 54 can be configured to generate an alerting signal only when all of the average brewing temperature values obtained in five consecutive coffee brewing operations reached the preset scale removal temperature.

It is noted that, when the water reservoir 2 is in an empty state, continued heating operation of the electric heating device 32 will result in a rapid increase in the temperature of the supply pipe 33 so that highest and lowest temperature samples cannot be relied upon for calculation of the average brewing temperature value by the processor 54. In this embodiment, when the temperature of the supply pipe 33 reaches a predetermined critical temperature (e.g., 200° C.), the processor 54 will provide a protective function. That is, the processor 54 will control the heater controller 51 to disrupt the supply of electricity to the electric heating device 32. As such protective function belongs to known circuit design, a detailed description of the same will be dispensed with herein for the sake of brevity.

The alert unit 55 is disposed on the front portion 312 of the housing 31. In this embodiment, the alert unit 55 includes an alert element 551, which is in the form of a liquid crystal display but is not limited thereto. The alert element 551 is connected to and is controlled by the processor 54 for scale removal indication upon receipt of the alerting signal from the processor 54. Particularly, the alert element 551 displays a predetermined alert sign thereon upon receipt of the alerting signal from the processor 54. For instance, the alert element 551 can be configured to show the word “Clean” thereon, as shown in FIG. 1, to indicate to the user that scale removal is necessary. The alert element 551 can also be controlled by the processor 54 to display thereon other information, such as temperature, time, etc., in a manner known to those skilled in the art.

It is noted that the alert element 551 can be any other suitable electronic device capable of audible or visible indication. In addition, the alert unit 55 can include a plurality of alert elements 551 for generating different forms of alerts.

It has thus been shown that the present invention is capable of accurately determining the time when scale removal is necessary regardless of the quality of the water used to brew coffee for timely alerting the user.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. An electronic coffee maker comprising:
a water reservoir for receiving water therein;
a base disposed at a lower end of said water reservoir, and including a housing, an electric heating device mounted in said housing, and a supply pipe in fluid communication with said water reservoir and heated by said electric heating device when electric power is supplied to said electric heating device;
a filter basket disposed above said base and disposed to receive heated water from said supply pipe; and
a control circuit mounted on said base, said control circuit including
a sensor unit for sensing temperature of said supply pipe and for generating a temperature signal corresponding to the temperature of said supply pipe,
a processor connected to said sensor unit, said processor determining an average brewing temperature value of said supply pipe from the temperature signal, and generating an alerting signal when the average brewing temperature value determined thereby reaches a preset scale removal temperature value, and
an alert unit connected to said processor and operable for scale removal indication upon receipt of the alerting signal from said processor.

2. The electronic coffee maker as claimed in claim 1, wherein said processor is configured to generate the alerting signal only when all of the average brewing temperature values obtained in a predetermined number of consecutive coffee brewing operations reached the preset scale removal temperature value.

3. The electronic coffee maker as claimed in claim 1, wherein the average brewing temperature value is a mean temperature value of highest and lowest temperature samples at each fluctuation of the temperature signal within a predetermined period of brewing time.

4. The electronic coffee maker as claimed in claim 1, wherein said alert unit includes a liquid crystal display mounted on said housing of said base.

5. The electronic coffee maker as claimed in claim 4, wherein said liquid crystal display is configured to show the word “Clean” thereon upon receipt of the alerting signal from said processor.
